(19) United States
(12) Patent Application Publication
(10) Pub. No.: US 2012/0031299 A1
(43) Pub. Date: Feb. 9, 2012

(54) Energy-Absorbing Device Particularly For A Shock Absorber For A Track-Guided Vehicle

(75) Inventor: Arthur Kontetzki, Salzgitter-Bad (DE)

(73) Assignee: VOITH PATENT GMBH, Heidenheim (DE)

(21) Appl. No.: 13/185,525

(22) Filed: Jul. 19, 2011

(30) Foreign Application Priority Data
Aug. 6, 2010 (EP) 10 172 194.2

(51) Int. Cl. B60R 19/26; B61G 11/00; B61D 15/06

(52) U.S. Cl. 105/392.5; 293/132

(57) ABSTRACT

An energy-absorbing device, particularly for a shock absorber of a track-guided vehicle, has an energy-absorbing element designed as a deformation tube and a counter element which interacts with the deformation tube such that upon a critical impact force being exceeded, the counter element and the deformation tube exhibit a relative movement toward one another while at least a portion of the impact energy introduced into the energy-absorbing device is simultaneously absorbed. For the energy absorbtion to take place according to a predictable sequence of events when force is introduced non-axially into the energy-absorbing device, the counter element is connected to the deformation tube by means of a form-fit connection circumferential to the deformation tube so as to prevent twisting of the counter element relative the deformation tube.

### CROSS-REFERENCE TO RELATED APPLICATION

This application claims priority to European Patent Application No. EP 10 172 194.2 filed Aug. 6, 2010 which is herein incorporated by reference.

### BACKGROUND OF THE INVENTION

1. Field of the Invention

The invention relates to an energy-absorbing device, in particular for a shock absorber of a track-guided vehicle, wherein the energy-absorbing device contains an energy-absorbing deformation tube as well as a counter element. The counter element interacts with the deformation tube such that upon exceeding a critical impact force introduced into the energy-absorbing device, the counter element and the deformation tube realize a relative movement toward one another while at least a portion of the impact energy introduced into the energy-absorbing device is simultaneously absorbed.

2. Background Art

The principle of an energy-absorbing device of the type described above is common knowledge in the prior art and is employed for example in rail vehicle technology, particularly as part of a shock absorber. In rail vehicles, such a shock absorber usually consists of a combination of a drawgear (e.g. in the form of a spring mechanism) and an energy-absorbing device comprising an irreversible energy-absorbing element, whereby the energy-absorbing element serves, in particular, to protect the vehicle against even higher rear-end collision speeds. Normally, the drawgear accommodates tractive and impact forces up to a defined magnitude and first routes forces which exceed this magnitude to the energy-absorbing element of the energy-absorbing device, and only then routes impact energy exceeding the energy level designed to be absorbed by the energy-absorbing element of the energy absorbing device to the underframe of the vehicle.

With a drawgear, the tractive and impact forces which occur during normal travel, for example between the individual car bodies of a multi-member railway vehicle are absorbed by this usually regeneratively-designed drawgear. However, when the operating load of the drawgear is exceeded, for instance upon the vehicle colliding with an obstacle, the drawgear and any articulated or coupling connection provided as an interface between the individual car bodies may possibly be destroyed or damaged. At higher collision energies, the drawgear is insufficient to absorb all of the resulting energy on its own. There is thereby the risk that the vehicle underframe or the entire car body will be used to absorb further energy, which subjects these components to extreme loads which may possibly damage or even destroy them. In such cases, rail vehicles would be at risk of derailing.

In order to protect the vehicle underframe against damage upon hard rear-end collisions, an energy-absorbing device having a destructively-designed energy-absorbing element is frequently utilized in addition to the normally regeneratively-designed drawgear. The energy-absorbing device may be designed, for example, to respond when the drawgear's working absorption capacity is exhausted, and at least partly absorb and thus dissipate the energy transmitted in the flow of force through the energy-absorbing element. It is of course however also conceivable to avoid any regeneratively-designed drawgear and to utilize only an energy-absorbing device having a destructively-designed energy-absorbing element to protect the vehicle underframe from damage upon rear-end collisions.

A deformable body is particularly applicable as an energy-absorbing element which, upon exceeding a critical compressive force, converts at least a portion of the impact energy into deformation energy and heat and thus “absorbs” it by intentional destructive plastic deformation. An energy-absorbing element which, for example, uses a deformation tube to absorb the impact energy exhibits a substantially rectangular characteristic curve, whereby maximum energy absorption is ensured after the energy-absorbing element has responded. However, such energy absorbing elements have provided unpredictable energy absorbtion in the past, in response to impacts which are oblique to the axis of the deformation tube. It would be desirable to provide an energy absorbtion device which can handle oblique forces in a predictable manner.

### SUMMARY OF THE INVENTION

The present invention is thus directed to an energy absorbing device containing a deformation tube and counter element which is capable of absorbing energy predictably, regardless of whether the energy conveyed to the energy absorbing device is parallel or oblique to the longitudinal axis of the deformation tube. These and other objects are achieved by a device in which the counter element is connected to the deformation tube by a form-fit connection circumferential to the deformation tube, which effectively prevents twisting of the counter element relative to the deformation tube.

### BRIEF DESCRIPTION OF THE DRAWINGS

FIG. 1 illustrates a longitudinally sectional representation of a shock absorber integrated into a coupler shank of a track-guided vehicle, whereby the shock absorber comprises a known prior art energy-absorbing device; and

FIG. 2 illustrates a perspective, partly sectional representation of an embodiment of the energy-absorbing device according to the invention which is particularly suitable for use in a shock absorber.

### DETAILED DESCRIPTION OF THE PREFERRED EMBODIMENTS

The term “counter element” as used herein is to be understood as a component of the energy-absorbing device which causes a plastic deformation of the energy-absorbing element upon activation of the energy-absorbing device. The counter element can, in particular, comprise a conical ring or be designed as a conical ring which is pressed into the energy-absorbing element designed as a deformation tube upon actuation of the energy-absorbing device and which deforms the deformation tube by plastic cross-sectional expansion.

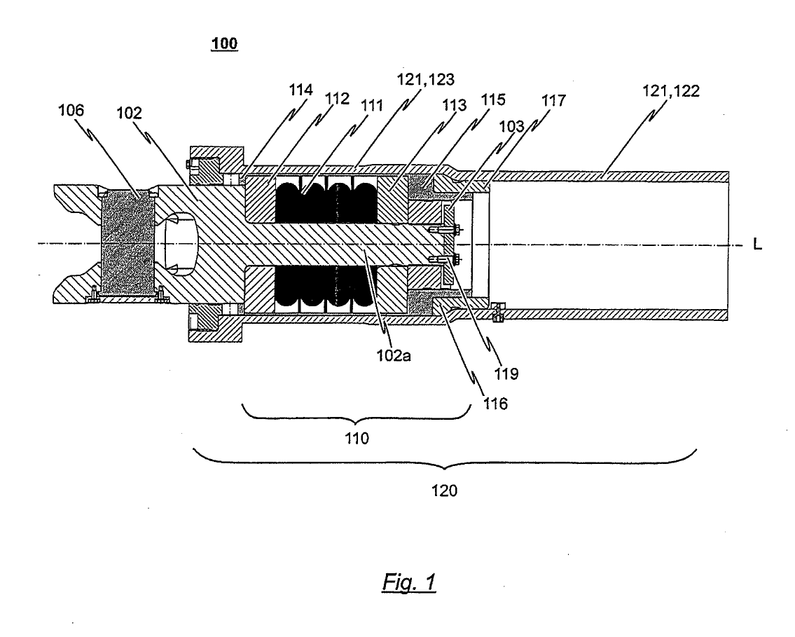

FIG. 1 schematically depicts a shock absorber 100 of the prior art in a longitudinal sectional view which comprises a drawgear 110 having a regeneratively-designed spring mechanism and a known prior art energy-absorbing device 120 having an irreversible energy-absorbing element 121. The shock absorber 100 depicted schematically in FIG. 1 is integrated into a coupler shank of a central buffer coupling.

In the embodiment depicted, the drawgear 110 of the shock absorber 100 is implemented in the form of a damping mechanism having regeneratively-designed spring elements 111, wherein the spring elements 111 serve to dampen the tractive and impact forces occurring during normal travel. In the shock absorber 100 depicted in FIG. 1, the tractive and impact forces occurring during normal travel are routed to the drawgear 110 implemented as a damping mechanism via a force-transferring element 102. In the shock absorber 100 depicted in FIG. 1, the force-transferring element 102 is configured as a fork at its coupling plane-side end which serves to receive a lug correspondingly configured complementary thereto, for example an articulated arrangement (not explicitly shown in FIG. 1). The fork and the lug received in the fork are mounted by means of a pivot pin 106 so as to be pivotable in the horizontal plane.

As already indicated, in addition to the drawgear 110 implemented as a damping mechanism, the shock absorber 100 depicted schematically in FIG. 1 comprises an energy-absorbing device 120 having a destructively-designed energy-absorbing element 121. The energy-absorbing device 120 serves to respond upon a predefinable critical impact force being exceeded and convert at least a portion of the impact forces transmitted by the energy-absorbing device 120 into heat and the work of deformation, and thus absorb them, by the plastic deformation of the energy-absorbing element 121.

As shown in FIG. 1, the energy-absorbing element 121 is designed as a deformation tube comprising a car body-side first deformation tube section 122 and an oppositely-disposed second deformation tube section 123. The second deformation tube section 123 exhibits a widened cross-section compared to the first deformation tube section 122. The drawgear 110 implemented as a damping mechanism is completely accommodated and thus integrated into the second deformation tube section 123 of the energy-absorbing element 121.

The damping mechanism has a first pressure plate 112 and a second pressure plate 113, between which the spring elements 111 of the spring mechanism are arranged. When the force-transferring element 102 introduces the tractive and impact forces which occur during normal travel into the shock absorber 100, in particular, the drawgear 110 configured as a damping mechanism, the two pressure plates 112, 113 are relatively moved toward one another by the distance between them being simultaneously contracted in the longitudinal direction of the drawgear 110. A first limit stop 114 for the first pressure plate 112 and a second limit stop 115 for the second pressure plate 113 are provided as mechanical stroke limiters. These two limit stops 114, 115 limit the longitudinal displacement of the two pressure plates 112, 113.

The force-transferring element 102 which routes tractive and impact forces to the drawgear 110 configured as a damping mechanism comprises a car body-side end section 102a which extends through the first pressure plate 112, the spring elements 111 of the spring mechanism and the second pressure plate 113 and has a counter element 103 at its car body-side end. The counter element 103 interacts with the second pressure plate 113 at least when tractive forces are being transmitted so as to transmit tractive force from the force-transferring element 102 to the second pressure plate 113. In the embodiment depicted in FIG. 1, the counter element 103 is connected to the car body-side end section 102a of the force-transferring element 102 via a bolted connection 119.

A conical ring 116 is provided at the transition between the first and the second deformation tube section 122, 123 which interacts with the second limit stop 115 such that the forces transmitted from the second pressure plate 113 to the second limit stop 115 during impact force transmission will be transmitted to the first deformation tube section 122 via the conical ring 116. The conical ring 116 comprises a guide element 117 which projects at least partly into the first deformation tube section 122 and abuts the inner surface area of the first deformation tube section 122.

The known prior art shock absorber 100 depicted in FIG. 1 is designed to dissipate impact energy resulting from the transmission of impact force over several stages: After the working absorption of the spring elements 111 provided in the drawgear 110 is exhausted, energy-absorbing device 120 responds. This ensues by the conical ring 116 arranged at the transition between the first and the second deformation tube section 122, 123 being pressed into the first deformation tube section 122. In consequence thereof, the cross-section of the first deformation tube section 122 is plastically expanded such that at least a portion of the transmitted impact forces are converted into the work of deformation and heat.

A disadvantage to the energy-absorbing device 120 employed in the shock absorber 100 according to FIG. 1 is that the conventional energy-absorbing device 120 is primarily designed only for impact forces introduced axially into the shock absorber 100. Energy absorption in accordance with a foreseeable sequence of events is only possible with an axial introduction of impact force in the conventional energy-absorbing device 120. This is however no longer ensured when impacts are introduced obliquely; i.e. non-axially, relative the longitudinal axis L of the energy-absorbing element 121 which is for example the case when a rail vehicle equipped with the energy-absorbing device 120 collides with an obstacle while traveling through a curve. When non-axial impacts are introduced into the energy-absorbing device 120, there is particularly the risk that the cracks inevitably forming in the deformation tube material upon the plastic deformation of the energy-absorbing element 121 configured as a deformation tube will not be rectilinearly parallel to the longitudinal axis L of the deformation tube 121. Instead, indiscriminate cracks running obliquely to the longitudinal axis L of the energy-absorbing element 121 will form in the deformation tube material, hence the energy absorption procedure can no longer be precisely predicted.

From this problem as posed, the invention is based on the task of further developing an energy-absorbing device of the type specified at the outset and as employed for example in the shock absorber 100 depicted in FIG. 1 such that energy can also be absorbed according to a predictable sequence of events when force is introduced non-axially. This task is solved according to the invention by the subject matter of independent claim 1. Advantageous further developments of the inventive energy-absorbing device are indicated in the dependent claims.

Accordingly, the solution according to the invention particularly provides for the counter element to be connected to the deformation tube via a form-fit connection circumferential to the deformation tube. This form-fit connection can effectively prevent a twisting of the counter element relative the deformation tube. Provision of such rotational protection increases the stability of the energy-absorbing device relative to lateral, i.e. non-axial, impact forces. Wedging of the counter element against the deformation tube can in particular also be effectively prevented when the counter element is pressed into the deformation tube after the energy-absorbing device has been actuated in response to the introduction of non-axial impact forces. The form-fit connection circumferential to the deformation tube between the counter element and the deformation tube simultaneously also serves as an axial guide to guide the relative movement of the counter element and the deformation tube upon the energy-absorbing device being actuated.

One preferred embodiment of the solution according to the invention provides for creating the form-fit connection circumferential to the deformation tube by at least one recess running parallel to the longitudinal axis of the deformation tube on the one hand, and on the other hand, by a guide rail formed complementary to the recess and which interacts with the recess, whereby the guide rail likewise runs parallel to the longitudinal axis of the deformation tube and is positively received by the recess. For example, it is conceivable to provide at least one recess running parallel to the longitudinal axis of the deformation tube at least in some areas on the inner surface area of the deformation tube and a guide rail configured complementary to the recess on the counter element, whereby the guide rail forms a form-fit connection with the recess. Alternatively or additionally hereto, it is conceivable to provide a guide rail running parallel to the longitudinal axis of the deformation tube at least in some areas of the inner surface area of the deformation tube and a recess configured complementary to the guide rail in the counter element in order to create the form-fit connection.

The term “recess” as used herein refers in particular to a groove or a notch. The term “guide rail” refers in general to a projecting region such as e.g. a fitted key. The guide rail can exhibit any arbitrary cross-sectional configuration such as, for example, a rectangular, triangular or rounded cross-sectional configuration and is configured complementary to the recess.

It is for example particularly preferred to provide the inner surface area of the deformation tube with fluting at least in some parts, wherein the flutings run parallel to the longitudinal axis of the deformation tube. The counter element is thereby to be provided with a surface structure complementary to the fluting provided on the inner surface area of the deformation tube.

According to a further advantageous embodiment of the inventive solution, the deformation tube comprises a first deformation tube section and an oppositely-disposed second deformation tube section, whereby the second deformation tube section is provided with a narrowed cross-section compared to the first deformation tube section and whereby the counter element is at least partly accommodated in the second deformation tube section. The counter element is thus within the interior of the second deformation tube section and guided in the deformation tube upon the energy-absorbing device being activated during the deformation process.

The solution according to the invention provides for the energy-absorbing element to be designed as a deformation tube which plastically deforms preferably by cross-sectional expanding upon the exceeding of a critical impact force introduced into the energy-absorbing element and permits the relative movement of the counter element. An energy-absorbing element configured in the form of a deformation tube is characterized by exhibiting a defined response characteristic without any force peaks. Due to the substantially rectangular characteristic curve, a maximum energy absorption is thus guaranteed after the energy-absorbing device has been actuated.

It is particularly preferred for the deformation tube to plastically deform by simultaneous cross-sectional expansion upon the energy-absorbing device being actuated. However, energy absorption by simultaneous cross-sectional decreasing of the deformation tube is of course also conceivable; it would hereto be necessary for the deformation tube to be pressed through a corresponding nozzle opening in order to be able to effect the plastic cross-sectional reduction. However, a deformation tube which plastically deforms by cross-sectional expansion upon the energy-absorbing device being actuated can prevent the deformation tube from being ejected out of the energy-absorbing device after being deformed, which would be the case with plastic deformation by cross-sectional reduction. For this reason, the embodiment with the deformation tube deformable by cross-sectional expansion is preferred at present.

With the inventive solution, the counter element accommodated in the first deformation tube section is pressed into the narrowed second deformation tube section after the energy-absorbing device responds. In consequence thereof, the cross-section of the second deformation tube section plastically expands so that at least a portion of the impact energy introduced into the energy-absorbing device during the transmission of impact force is converted into the work of deformation and heat. In order to be able to thereby realize an expanding of the cross-section of the second deformation tube section in a predictable way, the counter element preferably comprises a conical ring having an outer surface which tapers toward the second deformation tube section. This tapering outer surface of the conical ring abuts the inner surface area of the deformation tube in the transition area (shoulder region) between the first deformation tube section and the second deformation tube section.

One preferred embodiment of the solution according to the invention provides for the conical ring to comprise a guide element which at least partly projects into the second deformation tube section and abuts the inner surface area of the second deformation tube section. Providing such a guide element can achieve the counter element with the conical ring moving relative to the second deformation tube section according to a predictable sequence of events, particularly without any canting or wedging, upon the actuating of the energy-absorbing device.

Particularly preferred with the latter cited embodiment is providing for the guide section to be of annular configuration and to exhibit a longitudinal axis which corresponds to the longitudinal axis of the deformation tube. The guide surface provided to guide the relative movement of the counter element is maximized by the annular configuration to the guide section. It is of particular advantage to use the annular guide section to create the form-fit connection circumferential to the deformation tube between the counter element and the deformation tube. It is thus for example conceivable to provide at least one groove-like recess running parallel to the longitudinal axis of the deformation tube in the annular guide section which forms a form-fit connection with a projecting region provided in the inner surface area of the second deformation tube section and running parallel to the longitudinal axis of the deformation tube, wherein the projecting region is configured complementary to the groove-like recess and serves as a guide rail.

It is of course nevertheless also conceivable to provide a fluting over the entire outer surface of the annular guide section, whereby the individual flutings are formed parallel to the longitudinal axis of the deformation tube. In this case, the inner surface area of the second deformation tube section is to be configured with a surface structure configured to be correspondingly complementary thereto.

By suitably selecting the wall thickness of the deformation tube and particularly the second deformation tube section and/or by suitably selecting the material of the deformation tube, in particular the second deformation tube section, and/or by suitably selecting the degree of expansion of the second deformation tube section effected by the conical ring upon the actuating of the energy-absorbing device, it is possible to predefine the critical impact force at which the energy-absorbing device is to respond. Advantageously, this critical impact force should be of an order of magnitude at which the damping property of a damping mechanism provided, for example, additionally to the energy-absorbing device, is exhausted.

The response force and the maximum amount of energy which can be absorbed by the energy-absorbing device can furthermore be predefined and precisely adapted to specific applications if the energy-absorbing element configured as a deformation tube is braced between a limit stop element on one side and the counter element on the other. This thus in particular ensures a slack-free integration of the energy-absorbing device into e.g. a shock absorber. In order to exert a suitable pretensioning on the deformation tube and thus be able to influence or predefine the response characteristic of the energy-absorbing device, it is conceivable to make use of a tensioning device connected on one side to the counter element and on the other to the limit stop element and which clamps the deformation tube between the counter element and the limit stop element by exerting tractive force acting both on the counter element as well as on the limit stop element.

The energy-absorbing device according to the invention is particularly suitable as part of a shock absorber for a railway vehicle. For example, it is conceivable to use the inventive energy-absorbing device in the shock absorber 100 depicted in FIG. 1 as referred to above, wherein the conventional deformation tube 121 can then be omitted.

Depicted schematically in FIG. 1 in a longitudinally-sectional representation is a shock absorber 100 comprising a drawgear 110 having a regeneratively-configured spring mechanism on the one hand and a known prior art energy-absorbing device 120 comprising an irreversible energy-absorbing element 121 on the other. The shock absorber 100 depicted schematically in FIG. 1 is integrated into a coupler shank of a central buffer coupling.

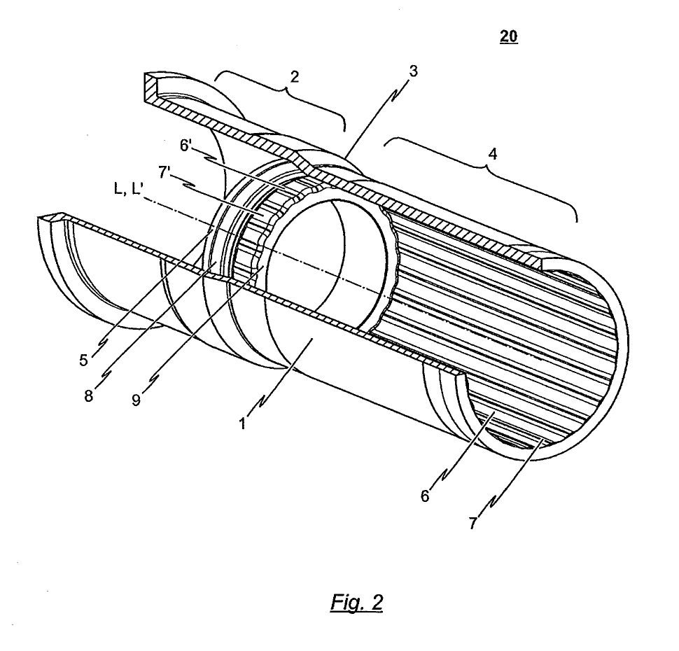

FIG. 2 depicts an embodiment of the inventive energy-absorbing device 20 in a perspective, partly sectional representation. This energy-absorbing device 20 is suitable for example as part of the shock absorber 100 shown in FIG. 1.

In accordance with the representation of FIG. 2, the exemplary embodiment of the energy-absorbing device 20 according to the invention comprises an energy-absorbing element in the form of a deformation tube 1. The deformation tube 1 consists of a first deformation tube section 4 and an oppositely-disposed second deformation tube section 2. The second deformation tube section 2 exhibits a widened cross-section compared to the first deformation tube section 4. A shoulder region 3 is provided between the first deformation tube section 4 and the second deformation tube section 2.

In addition to deformation tube 1, the energy-absorbing device 20 in accordance with the exemplary embodiment depicted in FIG. 2 comprises a counter element 5 which is accommodated in the second deformation tube section 2 of widened cross-section. The counter element 5 comprises a conical ring 8 with an outer surface tapering toward the first deformation tube section 4. As depicted in FIG. 2, this conically-tapering outer surface of the conical ring 8 abuts the inner surface area of the deformation tube 1 in shoulder region 3.

The conical ring 8 is furthermore provided with a guide element 9 which abuts the inner surface area of the first deformation tube section 4. Specifically, the guide element 9 is of annular configuration in the depicted embodiment and exhibits a longitudinal axis L′ which corresponds to the longitudinal axis L of the deformation tube 1.

The deformation tube 1 is configured so as to plastically deform by cross-sectional expansion upon a critical impact force introduced into the deformation tube 1 being exceeded, whereby the counter element 5 with the conical ring 8 and the guide element 9 thereby move relative to the deformation tube 1 toward the first deformation tube section 4. The characteristic impact force to actuate the deformation tube 1 can preferably be preset as a function of the wall thickness and/or the material of the deformation tube 1 and/or the degree of widening of the deformation tube 1.

In the exemplary embodiment of the energy-absorbing device 20 according to the invention depicted in FIG. 2, the counter element 5, and specifically the guide element 9 associated with the counter element 5, is connected to the deformation tube 1 by means of a circumferential form-fit connection to said deformation tube 1 so as to thus in particular effectively prevent a twisting of the counter element 5 relative the deformation tube 1 upon the energy-absorbing device 20 being actuated. The circumferential form-fit connection to said deformation tube 1 is formed by a plurality of recesses 6 which are formed in the inner surface area of the second deformation tube section 4 and run parallel to the longitudinal axis L of the deformation tube 1. In detail, the inner surface area of the first deformation tube section 4 exhibits a fluting, whereby the individual flutings (recesses 6) run parallel to the longitudinal axis L of the deformation tube 1.

On the other hand, the counter element 5, and specifically the annularly-configured guide element 9, is also provided with a corresponding fluted structure. The flutings configured on the outer surface of the annular guide element 9 run parallel to the longitudinal axis L of the deformation tube 1 and are configured complementary to the flutings provided in the inner surface area of the first deformation tube section 4. Thus, the flutings configured on the outer surface of the annular guide element 9 positively engage in the flutings formed in the inner surface area of the first deformation tube section 4 and thereby effect rotational protection of the counter element 5 relative the deformation tube 1. The flutings nevertheless serve as axial guiding means for the relative movement of the counter element 5 and the deformation tube 1. In detail, the form-fit connection circumferential to the deformation tube 1 between the deformation tube 1 and the counter element is formed on the one hand by the projecting regions (guide rails 7) of the flutings configured in the inner surface area of the first deformation tube section 4 positively engaging in the recesses 6′ configured in the outer surface of the annular guide element 9 and, on the other hand, by the projecting regions (guide rails 7′) of the flutings configured in the outer surface of the annular guide element 9 positively engaging in the recesses 6 configured in the inner surface area of the first deformation tube section 4.

Although it is not explicitly depicted in FIG. 2, it is of course also conceivable for only one recess 6 running parallel to the longitudinal axis L of the deformation tube 1 to be provided on the inner surface area of the deformation tube 1, for example in the form of a groove or a notch, in order to create a form-fit connection with a guide rail 7′ provided on counter element 5 which is configured complementary to the recess 6. Said guide rail 7′ can in particular also be realized as a fitted key.

The guide rail 7, respectively the projecting region running parallel to the longitudinal axis L of the deformation tube 1, can exhibit a rectangular, triangular or also even a rounded cross-section.

The invention is not limited to the embodiment depicted above as an example with reference to the FIG. 2 representation but rather yields from a synopsis of all the features disclosed herein together.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An energy-absorbing device comprising an energy-absorbing element comprising a deformation tube having an inner surface and a longitudinal axis L and a counter element which interacts with the deformation tube such that upon exceeding a critical impact force introduced into the energy-absorbing device the counter element and the deformation tube exhibit relative movement toward one another while at least a portion of the impact energy introduced into the energy-absorbing device is simultaneously absorbed by deformation of a portion of the deformation tube by the counter element, the counter element connected to the deformation tube by a form-fit connection circumferential to the deformation tube to prevent twisting of the counter element relative the deformation tube.

2. The energy-absorbing device of claim 1, attached to a track-guided vehicle.

3. The energy-absorbing device of claim 1, wherein at least one recess running parallel to the longitudinal axis L of the deformation tube is provided in at least a portion of the inner surface of the deformation tube to form a form-fit connection with a guide rail configured complementary to the recess provided on the counter element.

4. The energy-absorbing device of claim 3, wherein the recess is in the form of a groove or notch.

5. The energy-absorbing device of claim 3, wherein the guide rail comprises a fitted key.

6. The energy-absorbing device of claim 1, wherein at least one guide rail running parallel to the longitudinal axis L of the deformation tube is provided on at least portions of the inner surface of the deformation tube to form a form-fit connection with a recess in the counter element configured complementary to the guide rail.

7. The energy-absorbing device of claim 3, wherein at least one guide rail running parallel to the longitudinal axis L of the deformation tube is provided on at least portions of the inner surface of the deformation tube to form a form-fit connection with a recess in the counter element configured complementary to the guide rail.

8. The energy-absorbing device of claim 4, wherein at least one guide rail running parallel to the longitudinal axis L of the deformation tube is provided on at least portions of the inner surface of the deformation tube to form a form-fit connection with a recess in the counter element configured complementary to the guide rail.

9. The energy-absorbing device of claim 3, wherein the guide rail(s) exhibit a rectangular, triangular or rounded cross-sectional configuration.

10. The energy-absorbing device of claim 1, wherein fluting(s) having recesses running parallel to the longitudinal axis L of the deformation tube is provided on at least a portion of the inner surface of the deformation tube to form a form-fit connection with fluting(s) configured correspondingly thereto on the counter element.

11. The energy-absorbing device of claim 1, wherein the deformation tube comprises a first deformation tube section and an oppositely-disposed second deformation tube section, wherein the second deformation tube section is provided with a narrowed cross-section compared to the first deformation tube section and wherein the counter element is at least partly received in the second deformation tube section.

12. The energy-absorbing device of claim 11, wherein the first deformation tube section is connected to the second deformation tube section via a shoulder region, and wherein the counter element comprises a conical ring having an outer surface which tapers toward the second deformation tube section and abuts the inner surface of the deformation tube in the shoulder region.

13. The energy-absorbing device of claim 12, wherein the conical ring comprises a guide element which abuts the inner surface of the first deformation tube section.

14. The energy-absorbing device of claim 13, wherein the guide element is of annular configuration and exhibits a longitudinal axis L′ which corresponds to the longitudinal axis L of the deformation tube.

15. The energy-absorbing device of claim 14, wherein at least one groove-like recess running parallel to the longitudinal axis L of the deformation tube is provided in the annular guide element to form a form-fit connection with a projecting region provided in the inner surface of the first deformation tube section and runs parallel to the longitudinal axis L of the deformation tube which is configured complementary to the groove-like recess and serves as a guide rail.

16. The energy-absorbing device of claim 1, wherein the deformation tube is configured so as to plastically deform upon a critical impact force introduced into the deformation tube being exceeded and permit relative movement of the deformation tube and the counter element.

17. The energy-absorbing device of claim 16, wherein the impact force for actuating the deformation tube is preset by means of the wall thickness and/or the material of the deformation tube and/or by the degree of expansion of the deformation tube.

18. The energy-absorbing device of claim 1, wherein the deformation tube is braced between the counter element and a limit stop element by at least one tensioning element such that a defined pretensioning is exerted on the deformation tube, by means of which the response characteristic of the energy-absorbing device is predefined.

19. The energy-absorbing device of claim 18, wherein the tensioning device is connected on one side to the limit stop element and on the other to the counter element, and received by the deformation tube.

20. A method of absorbing impact energy by an energy absorbing device, comprising absorbing impact energy by the plastic deformation of the energy absorbing device of claim 1.
